(19) United States
(12) Patent Application Publication
(10) Pub. No.: US 2019/0287124 A1
(43) Pub. Date: Sep. 19, 2019

(54) TRADESHOW VENDOR MANAGEMENT SYSTEM

(71) Applicants: Robert Richard Milam, West Jordan, UT (US); Charles Wesley Cozad, III, Citrus Heights, CA (US)

(72) Inventors: Robert Richard Milam, West Jordan, UT (US); Charles Wesley Cozad, III, Citrus Heights, CA (US)

(21) Appl. No.: 16/354,456

(22) Filed: Mar. 15, 2019

Related U.S. Application Data
(60) Provisional application No. 62/643,878, filed on Mar. 16, 2018.

(51) Int. Cl. G06Q 30/02; G06F 16/9035

(52) U.S. Cl. CPC G06Q 30/0205; G06F 16/9035; G06Q 30/0201

(57) ABSTRACT

Managing vendors and exhibit spaces of tradeshows. In an embodiment, a user input is received. Based on the user input, a target audience profile is determined. A databased that includes information about a set of members of an audience attending an even is accessed. The information includes one or more attributes of each of the set of members. Based on the determined target audience profile and the information related to the set of members of the audience attending the event, a subset of members whose attributes substantially match the target audience profile is identified. Based on the identified subset of members, a target audience reach is determined.

### CROSS-REFERENCE TO RELATED APPLICATIONS

This application claims the benefit of and priority to U.S. Provisional Patent Application Ser. No. 62/643,878 filed on Mar. 16, 2018, entitled “Exhibit Space Generator,” which is incorporated herein by reference in its entirety.

### BACKGROUND OF THE INVENTION

A trade show, trade fair, trade exhibition, or expo is an exhibition organized so that companies in a specific industry can showcase and demonstrate their latest products and services, meet with industry partners and customers, study activities of rivals, and examine recent market trends and opportunities. Trade shows play important roles in marketing as well as business networking in many market sectors. Most trade shows are annual, and some trade shows occur every two to four years. Many trade shows have consistent participation of exhibitors (also referred to as vendors) and attendees.

Generally, in a tradeshow, there will be a central trade show floor with booths where businesses exhibit their goods and/or services. The total size of the floor area often arranges between a few hundred thousand square feet and a few million square feet. The central floor area is divided into many individual exhibit spaces, e.g., 10′×10′, 10′×20′, etc. The exhibitors can rent one or more different sizes of the exhibit spaces depending on their budgets and goals.

Each exhibitor is often interested in one or more specific types of attendees, which are called a target audience. For example, some exhibitors may seek to meet its potential suppliers and/or potential buyers and some exhibitors may seek to meet companies at their own level in the supply chain. Attendees often also have their target exhibitors. Typically, attendees walk around in the central trade show floor and stop by at the booths of the exhibitors that they are interested in. Exhibitors will often have employees standing or sitting at the booth to answer questions and/or distribute brochures or/and other marketing materials.

The total number of audience members who stop at a booth of an exhibitor is called “audience reach”. Since not every attendee will stop at every booth, the “audience reach” is usually a percentage of the total number of attendees. Also, since not every attendee is targeted, the total number of the target audience members who stop at the booth of an exhibitor is called “target audience reach.” The “target audience reach” is generally a percentage of the “audience reach.” The ultimate goal for most of the exhibitors is to have a higher target audience reach at a cost that is still under the budget.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

Embodiments disclosed herein are related to computing systems, computer program products, and methods for managing vendors and exhibit spaces of tradeshows. In the embodiment, a user input is received. Based on the user input, a target audience profile is determined. A database that includes information about a set of members of an audience attending an event is accessed. The information includes one or more attributes of each of the set of members. Based on the determined target audience profile and the information about the set of members of the audience attending the event, a subset of members whose attributes substantially match the target audience profile is identified. Based on the identified subset of members, a target audience reach is determined.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and details through the use of the accompanying drawings in which:

FIG. 1 illustrates an example computing system in which the principles described herein may be employed;

FIG. 2 illustrates an embodiment of an environment in which a management system for managing vendors and exhibit spaces of tradeshows may be implemented;

FIG. 3 illustrates an example embodiment of a vendor and exhibit space management module for generating recommendations for users;

FIG. 4 illustrates a flow chart of an example method for managing vendors and exhibit spaces of tradeshows;

FIGS. 5A and 5B illustrate example user interfaces for generating recommendations for a user; and

FIG. 6 illustrates a flow chart of an example method that may be implemented at a terminal device that is configured to interface with a user and display recommendations based on the user inputs.

### DETAILED DESCRIPTION

Embodiments disclosed herein are related to computing systems, computer program products, and methods for managing vendors and exhibit spaces of tradeshows. In the embodiment, a user input is received. Based on the user input, a target audience profile is determined. A database that includes information about a set of members of an audience attending an event is accessed. The information includes one or more attributes of each of the set of members. Based on the determined target audience profile and the information about the set of members of the audience attending the event, a subset of members whose attributes substantially match the target audience profile is identified. Based on the identified subset of members, a target audience reach is determined.

The principles described herein allow a tradeshow exhibitor to see its potential target audience reach for one or more particular exhibit space before making a purchase decision. For example, most of the exhibitors purchase the minimum space at tradeshows, at least partially because they do not know whether a larger space or a different space would help them reach a greater number of target audience members. If an exhibitor knows that a larger space may be able to increase its target audience reach significantly at a small cost, it will likely rent a larger space. Further, the principles described herein also helps the tradeshow organizers to market its tradeshow and available exhibit spaces more accurately and to meet each exhibitor's different needs and expectations.

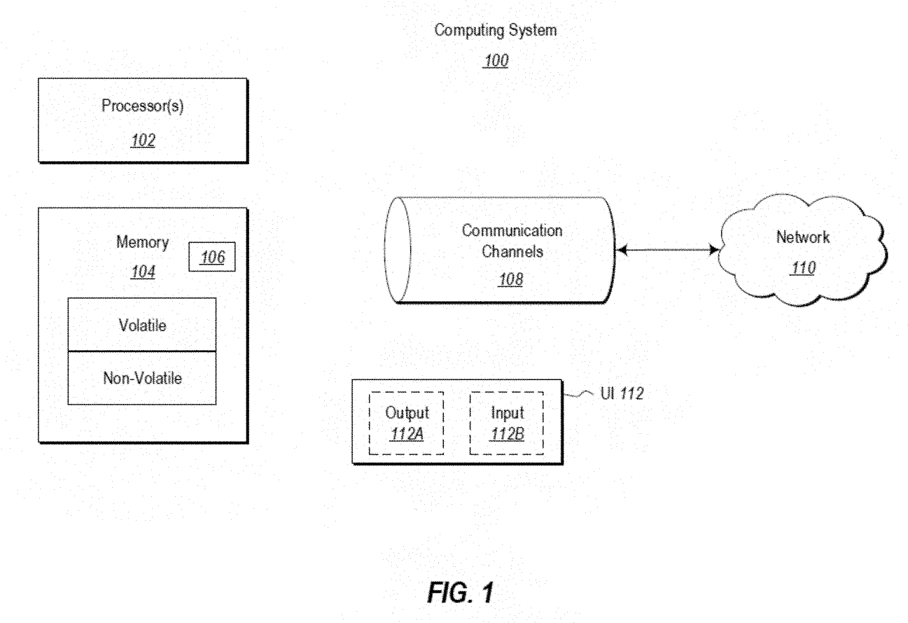

Because the principles described herein may be performed in the context of a computing system, some introductory discussion of a computing system will be described with respect to FIG. 1. Then, this description will return to the principles of tradeshow vendor and exhibit space management with respect to the remaining figures.

Computing systems are now increasingly taking a wide variety of forms. Computing systems may, for example, be handheld devices, appliances, laptop computers, desktop computers, mainframes, distributed computing systems, data centers, or even devices that have not conventionally been considered a computing system, such as wearables (e.g., glasses). In this description and in the claims, the term “computing system” is defined broadly as including any device or system (or a combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The processing unit 102 may include a general purpose processor and may also include a field programmable gate array (FPGA), an application specific integrated circuit (ASIC), or any other specialized circuit. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 100 also has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures, such as hard coded or hard wired logic gates, that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data. If such acts are implemented exclusively or near-exclusively in hardware, such as within an FPGA or an ASIC, the computer-executable instructions may be hard coded or hard-wired logic gates. The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface system 112 for use in interfacing with a user. The user interface system 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms and so forth. Examples of input mechanisms 112B might include, for instance, microphones, touchscreens, holograms, cameras, keyboards, mouse of other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM, or other optical disk storage, magnetic disk storage, or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RANI and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing system, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

The remaining figures may discuss various computing system which may correspond to the computing system 100 previously described. The computing systems of the remaining figures include various components or functional blocks that may implement the various embodiments disclosed herein as will be explained. The various components or functional blocks may be implemented on a local computing system or may be implemented on a distributed computing system that includes elements resident in the cloud or that implement aspects of cloud computing. The various components or functional blocks may be implemented as software, hardware, or a combination of software and hardware. The computing systems of the remaining figures may include more or less than the components illustrated in the figures and some of the components may be combined as circumstances warrant. Although not necessarily illustrated, the various components of the computing systems may access and/or utilize a processor and memory, such as processor 102 and memory 104, as needed to perform their various functions.

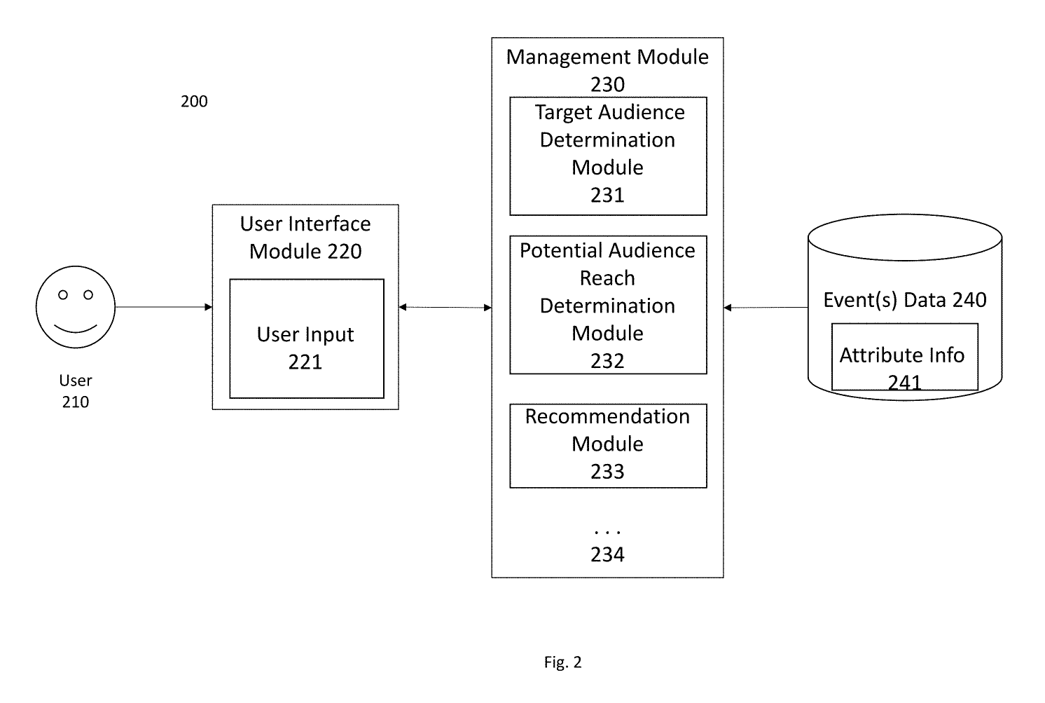

FIG. 2 illustrates an embodiment of an environment 200, in which a management system for managing vendors and exhibit spaces of tradeshows may be implemented. As illustrated in FIG. 2, the environment 200 includes a management module 230 that receives information from a user interface module 220 and an event data system 240. The management module 230 may include a target audience determination module 231, a potential audience reach determination module 232, a recommendation module 233, etc. The ellipsis 234 represents that there may be one or more other modules configured to perform additional functions in the management module 230.

A user 210 may interact with the user interface module 220 and input user information 221 into the management module 230. The user interface 220 may be a touch screen, a tablet, a monitor with a mouse and keyboard, etc. The user 210 may be an exhibitor who has committed to an exhibit space of the current or future event. Alternatively, the user 210 may be a potential exhibitor who has not committed to an exhibit space of the current or future event yet. In either case, the user 210 may input its business related information, such as whether the user 210 is a manufacturer for making a particular product, whether the user 210 is a distributor for distributing a particular product, whether the user 210 is a retailer for selling a particular product, the price range of the user's product, the complexity of the user's business, etc.

The user 210 may also input its goal or purpose of attending the tradeshow, such as what type of businesses the user is interested in reaching, what type of job titles of the attendees the user is interested in meeting with, what type of products the user is interested in, budget for attending the tradeshow, etc.

After the management module 230 receives the business related information and/or business purpose from the user, the target audience determination module 231 determines a target audience profile that the user 210 may be interested. For example, if a user is a manufacturer of a particular product, the user may be interested in the distributors that distribute the particular product. Accordingly, the target audience profile may include all the distributors that distributes the particular product. Another example, if a user is a service provider (e.g., an insurance service provider), the user may be interested in an audience that is geographically local or near the location the user provides the service. Accordingly, the target audience profile may include all the attendees that reside within 100 miles of the user's business location or the attendees that reside within a particular state.

Further, the user 210 may be an exhibitor who has attended the past events. In such a case, the user 210 may also input its relevant information related to the past event. For example, the user 210 may input the size and/or location of the exhibit space it has rented for the past event and its previous events target audience reach. Alternatively, the user 210 may be a new exhibitor, who does not know anything about the past events. In such a case, the user may skip the input fields that are related to the past events.

Also, the user 210 may have decided what size and/or location of the exhibit space he/she wants to rent in the current or future event. In such a case, the user 210 may also input the desired size and/or location of the exhibit space. Alternatively, the user 210 may not know what size and/or location of the exhibit space he wants to rent in the current or future event. Thus, the user 210 may also skip the input fields that are related to the current size and/or location of the exhibit space.

The management module 230 also has access to the event(s) data 240. The event(s) data may be data related to one or more past events, or data related to the current or future event. Such event(s) data often can be obtained from the tradeshow organizer. For example, most of the tradeshows occur annually. The tradeshow organizers often require visitors to register before entering the event. The gathered registration information often includes the visitor's attribute information 241, such as the visitor's organization name, organization type, job title, geographic location, purpose of attending the event, etc.

Next, based on the determined target audience profile and the event(s) data 240, the management module 230 further accesses the event(s) data 240. There may be laws and rules such as GDRP related to disclosing such information, especially attendee's contact information. Accordingly, the management module 230 may be configured not to access the attendees' private information that implicates privacy issues. Accordingly, the management module 230 may be configured to only access information related to the user 210's input. For example, when the user 210's input indicates that the user 210 is interested in the attendees that have a particular job title, only job title related attributes of each attendee need to be accessed by the management module 230. For example, each attendee's name, contact, address, and other private information need not be accessed. Another example, if the user 210 is interested in attendees from a particular geographic area, only the geographic area related attributes of each attendee need to be accessed by the management module 230. For example, only the partial address information (e.g., city and states) of each attendee may need to be accessed.

Based on the accessed event(s) data 240, the potential audience reach determination module 232 is configured to determine a subset of the attendees whose attribute substantially match the target audience profile. For example, if the user's input indicates that the user is interested in attendees from a particular geographic area, only the attendees whose business address or personal address is within the particular geographic area will be determined to be part of the target audience. Based on the identified subset of the attendees that are determined to be part of the target audience, a target audience reach is then determined.

Since not every attendee will visit every single table, only a subset of the target audience will be included in the target audience reach. The target audience reach is not only related to the size and/or location of the exhibit space (e.g., booth), it is also related to the complexity of the exhibitor's business, the price range of the exhibitor's product, the exhibitor's staff situation, the overall length of the event, etc. For example, an exhibitor who sells simple and low-cost products and/or services may need less time to make a sales speech and thus will be able to reach a larger target audience within a predetermined time period.

As another example, an exhibitor, who sells complex and high cost products and/or services, may need more time to make a sales speech. Also, a well-staffed exhibitor is likely to reach a larger target audience than an under-staffed exhibitor. Such relevant information may be input directly by the user 210 and/or be derived indirectly based on some related user input. Taking into account at least some of the above-mentioned information, the potential audience reach determination module 232 is configured to determine a target audience reach for the user 210. The target audience reach may be a maximum target audience reach for the user, e.g., the estimated audience reach based on the largest exhibit space available. Another example, the target audience reach may be a target audience reach for the user based on the largest exhibit space that is within the user 210's budget.

Further, based on the business-related information that is input by the user, the recommendation module 233 may be configured to generate a recommendation to the user. The recommendation may be one or more of a recommendation of a size and/or location of the exhibit space, a business plan, and/or other business recommendations. For example, if a user 210's goal is to reach 200 attendees that belong to the target audience, but his or her currently planned exhibit space will only support 100 such attendees, the recommendation module 233 may recommend that the user 210 rent a larger exhibit space, staff more employees at the event, place additional promotions on any fliers or other handouts, banners, and/or large screens, etc.

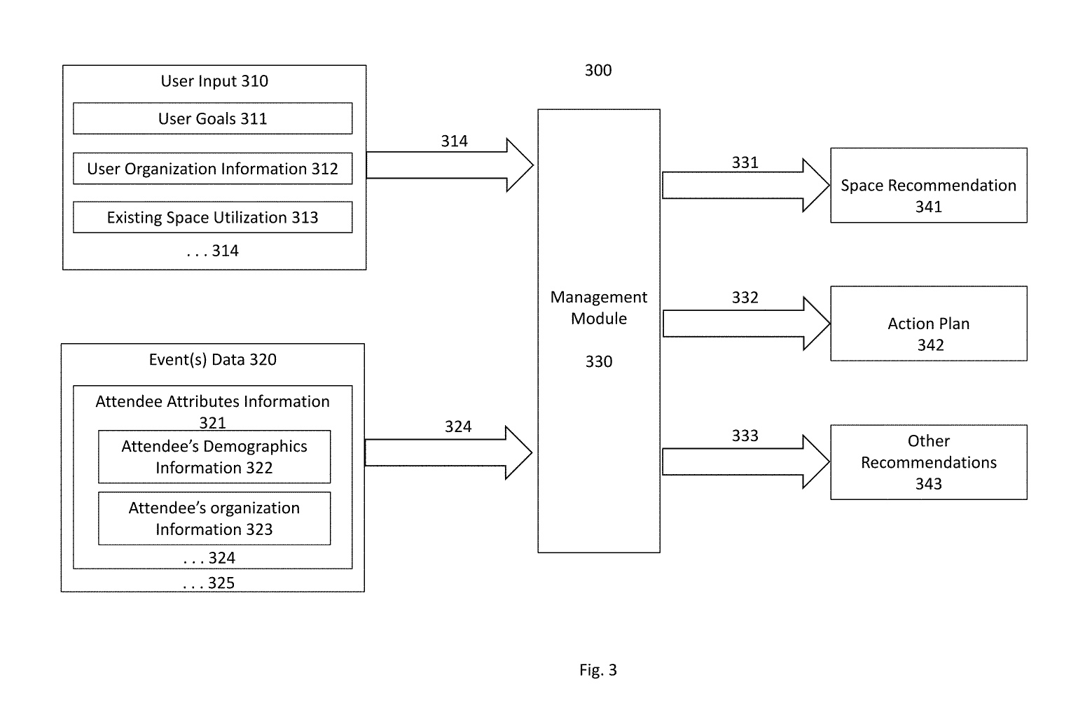

As another example, if a user 210 has a goal to reach 200 target attendees, but the management module 230 has determined that the total number of attendees that belong to the target audience or the maximum target audience reach is less than 50, the recommendation module 233 may recommend the user not to participate the tradeshow, because the tradeshow does not match the user's business goal. Further details about the recommendation module 233 will be described below with respect to FIG. 3.

FIG. 3 illustrates an example embodiment 300 of a vendor and exhibit space management module 330 for generating recommendations for users. The management module 330 of FIG. 3 may correspond to an embodiment of the management module 230 or the recommendation module 233 of FIG. 2. The management module 330 receives information user input 310 and event(s) data 320. Based on the received information, the management module 330 may generate a space recommendation 341, an action plan 342, and/or other recommendations 343. The user input 310 may include user goals 311, user organization information 312, existing space utilization information 313, etc. The ellipsis 314 represents that the user input 310 may include any other information that may be relevant to a past, current, and/or future tradeshow and/or event.

The event(s) data 320 includes at least attendee attributes information 321. For example, the attendee attributes information 321 may include (but is not limited to) attendee's demographics information 322 and/or attendee's organization information 323. The ellipsis 324 represents that there may be any additional information that is part of the attendee's attributes information. The ellipsis 325 represents that the event(s) data 320 may include additional information that is not part of the attendee attributes information 321.

The arrows 314 and 324 represent that the user input 310 and the event(s) data 320 are sent to the management module 330. The arrows 331, 332 and 333 represent that based on the received user input 310 and the event(s) data 320, the management module 330 may generate one or more space recommendation(s) 341, action plans 342, and other recommendations 343. These recommendations 341, 342 and/or 343 may then be presented to the user via the user interface 220 (of FIG. 2). Through the same user interface 220, the user may be able to further interact with the recommendations 341, 342 and/or 343 to accept, modify and/or deny the recommendations 341, 342, and/or 343.

Certain user information is intuitively related to certain attributes of attendees. Such information may be automatically linked to those related attributes of attendees by the management module 330. There may also be certain user information that is not apparently relevant to certain attributes of attendees. However, various machine learning technologies may be implemented to identify relationships between the user's information and the attendees' attributes. These machine learning identified relationships may also be used by the management module 330 to generate recommendations for the user. In some embodiments, the same tradeshow organizer's past event data may be used to generate recommendations for a current or future event. In some embodiments, other tradeshow organizer's event(s) data may also be used to perform machine learning, and such machine learning results may also be used to generate recommendations for the current tradeshow.

In some embodiments, the management module 330 may be a cloud service that is remote from the user interface and the event(s) data storage. Multiple different event organizers may subscribe to the cloud service and provide their own event(s) data via a computer network to the cloud service. Such an embodiment may allow the cloud service provider to have a more flexible pricing schemes. For example, the cloud service provider may charge different fees for different modules that are subscribed by the event organizer. Some event organizers may only want to subscribe to the recommendation service for recommending the size of the exhibit space. Some event organizers may want to subscribe certain services for one event, and not to subscribe certain services for another event. The cloud service provider may charge a lower fee for the event organizers that subscribe less modules, and charge a higher fee for the event organizers that subscribe more modules. The cloud service provider may also charge a service fee based on the total number of users that used the service. The cloud service provider may also charge a service fee based on total number of users that have decided to upgrade to a larger space or to purchase additional promotions from the organizer. The cloud service provider may also charge a service fee based on the total additional profit the event organizer received. For example, if 20% of the users decided to upgrade to a larger space after using the management system, and the total additional profit the event organizer received is about $200,000, the cloud service provider may receive a portion (e.g., 20%) of the $200,000.

In some embodiments, the user interface may be a mobile app installed on a user's phone, such that the users can play with the numbers at home or at work before committing to the event. In some embodiments, the user interface may be a computer or a kiosk that includes a touch screen, a keyboard, and/or a mouse placed at the event, such that the users can sign up for an exhibit space at the venue, and/or update their existing plans.

In some embodiments, the management module 330 may be local to the event(s) data storage. The event organizers may install the management module 330 on their local computing systems. The user interface may be directly connected to the computing system that implements the management module 330 and the event(s) data storage. Alternatively, the user interface may be connected to the management module 330 and the event(s) data via local area network (LAN), and/or local wireless network, etc.

Having described the example embodiment of the management module 230 and/or 330, we will now describe a number of methods and methods act that may be implemented on a computing system to perform the functions of the management module 230 and/or 330. Although the method acts may be discussed in a certain order or illustrated in a flow chart as occurring in a particular order, no particular ordering is required unless specifically stated, or required because an act is dependent on another act being completed prior to the act being performed.

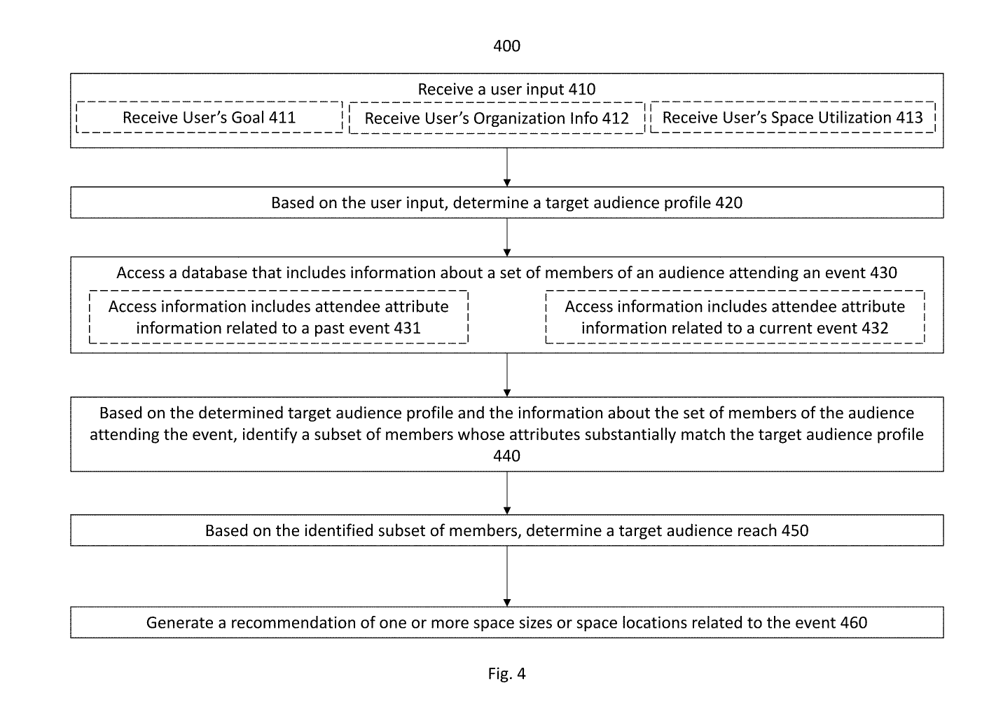

FIG. 4 illustrates a flow chart of an example method 400 for managing vendors and exhibit spaces of tradeshows. The method 400 includes receiving a user input (410). The receiving the user input 410 may include receiving the user's goal 411, receiving the user's organization information 412, and/or receiving the user's space utilization 413. The user's goal may include what type of business the user is interested in, what type of job titles of attendees the user is interested in meeting with, what geographic areas the user is interested in, etc. The user's organization information may include the type of the user's business, the product of the user's business manufactures or sells, the price range of the user's products and/or services, the complexity of the user's business, etc. The user's space utilization information 413 may be information related to the user's space utilization in a past event or information related to the user's planned space utilization in the current or future event.

The method 400 further includes determining a target audience profile based on the user input (420). The target audience profile may be an audience that has particular attributes. For example, if the user is a manufacturer for producing particular products, the user is likely to be interested in meeting the distributors of the particular products or the type of products. Thus, the target audience profile will include distributors that distribute the particular products or the type of products that the user produces. For instance, if the user is a manufacturer of snack foods, the user may be interested in businesses including, but not limited to, convenience stores, gas stations, grocery stores, etc. Thus, the attendees that are employees or managers of convenience stores, gas stations, grocery stores will be part of the target audience profile. Another example, if the user is a local service provider (e.g., an insurance provider), the user is likely to be interested in businesses that are geographically local to the service provider or businesses located in a particular state. Thus, the attendees that are located in the particular area or a particular state will be part of the target audience profile.

The method 400 also includes accessing a database that includes information about a set of members of an audience attending an event (430). The set of members may be the attendees that have attended a past event or tradeshow 431, or attendees that have registered for the current or future event or tradeshow 432. Based on the determined target audience profile and the information about the set of members of the audience attending the event, a subset of members whose attributes substantially match the target audience is then identified (440). In other words, the determined target audience profile is applied to the event(s) database to identify a subset of the members in the event(s) database whose attributes or profile match the determined target audience profile.

Next, based on the identified subset of members, a target audience reach may be determined (450). This determination may be based on the user's input, past event statistics, and/or information obtained from other research resources. For example, the user may input its past event data, including the size and/or location of the exhibit space the user has rented and how many target attendees the user has reached in a past event. Based on the user's input, the management module may then determine a rate of target audience reach for a current or a future event. The target audience reach may also be determined based on statistics from the event organizers or independent research and studies by other parties or by the management service provider.

Thereafter, based on the determined target audience reach, a recommendation of one or more space sizes or space location related to the event may be generated (460). The recommendation may include a recommendation of a particular size and/or location of exhibit space that is available for the relevant event. The recommendation may be a recommendation of participating or not participating the event. The recommendation may include one or more business plans that include potential costs and profits. The recommendation may also include a recommendation of how many staff members should be employed at the event, and each of their tasks. The recommendation may also include specific marketing plans including available promotions that may be purchased at the event.

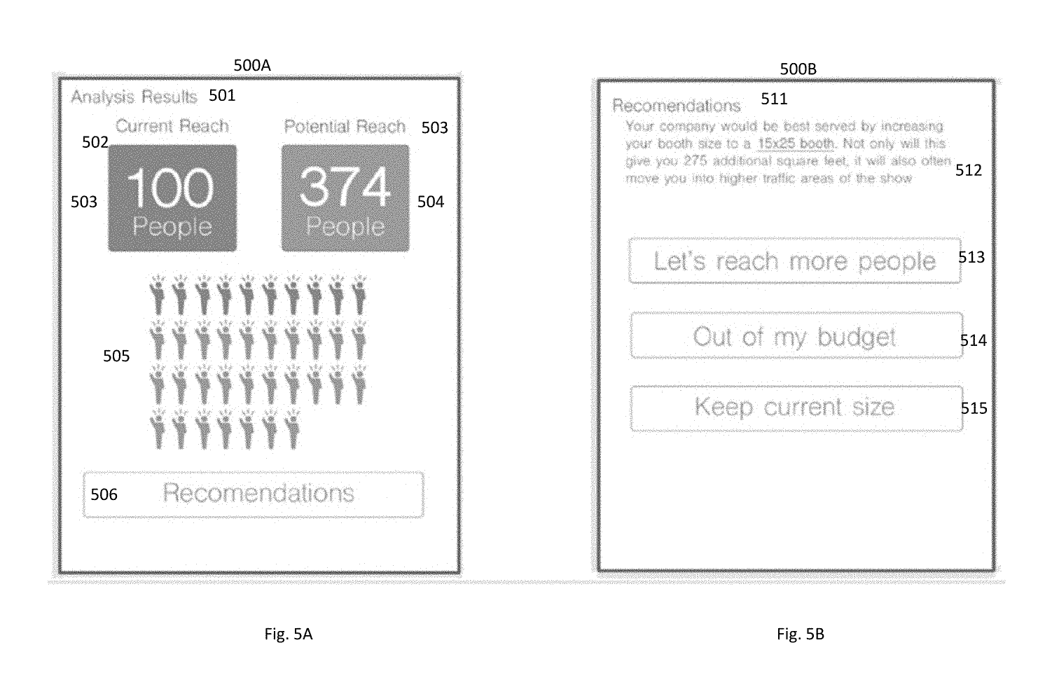

FIGS. 5A and 5B illustrate example user interfaces 500A and 500B for generating recommendations for a user. As briefly explained above, the user interface may be a terminal device placed at the event, or a user device (e.g., personal PC or mobile device) that is connected to a computer network and is configured to access the service of the management module.

FIG. 5A illustrates an example user interface 500A that displays the analysis results in 501 of the current reach 502 and potential reach 503. As illustrated in FIG. 5A, the current reach 502 is shown as 100 people 503, and the potential reach 503 is shown as 374 people 504. The current reach 502 is likely to be generated based on the previous user input. For example, the user may have input that he/she plans or has committed to rent a particular size and/or location of exhibit space (e.g., 10×10). The current reach 502 may be generated based on the size and/or location of exhibit space that the user inputs. Alternatively, the user may have participated in a past event, and have an estimated target reach based on the past event. In such a case, the user may input the particular size and/or location of exhibit space he/she has rented in a past event and the target reach of the past event. The user interface may then display the number the user has input. The potential reach 503 may be an estimate of the maximum possible target audience reach based on the user's input and the event(s) data.

The user interface 500A may further include a visualization 505 to visually depict the analysis results in the form of a chart or a figure. When analysis results include large numbers, it is easier for a user to see the analysis results in a chart form. For example, as illustrated in FIG. 5A, each person symbol may represent 10 people. First 10 person symbols represent 100 people which corresponds to the number of the estimated current target reach 502. The rest of the person symbols may represent the additional target audience that may be potentially reached, but may not be reached under the user's current plan. The first 10 person symbols may be colored in one color, e.g., blue. The rest of the person symbols may be colored in another color, e.g., grayed out. The visualization 505 illustrated in FIG. 5A is merely one example of visually presenting the analysis results. Other charts may be generated to display the same or additional analysis results. Further, animations may also be displayed to illustrate the analysis results, such as potential gain or loss, etc. What types of charts and/or animations are to be displayed to the user may be determined by the service of the management module, the event organizer and/or the user.

Furthermore, there is a “recommendation” button 506 placed at the bottom of the user interface 500A. Once the “recommendation” button 506 is clicked, the user will receive an individualized recommendation based on his/her input. The “recommendation” may be displayed as a text message, a graphic visualization illustrating the recommended contents, and/or a combination thereof. Further, animations may also be displayed to illustrate the recommended plans. FIG. 5B illustrates an example user interface 500B displaying a recommendation to a user.

Referring to FIG. 5B, the user interface 500B includes a title 511 as “recommendation”. Under the title 511, a text field 512 is displayed to explain what the recommendation is. For example, as illustrated in FIG. 5B, the text field 512 recommends the user to increase his/her booth size to a 15×25 booth, because not only will this give the user 275 additional squire feet, it will also often move the user into higher traffic areas of the show. The recommendation may also include the price and/or location of the recommended booth. The recommendation may also include the potential financial gain of the user by renting the recommended both. For example, the increased potential target reach may be translated to a number of sales, and the number of sales may be translated to a dollar amount of profit. Furthermore, the net gain may be estimated based on the potential dollar amount of profit and the additional cost of renting a larger space. The potential number of sales, the potential dollar amount of profit, and/or net gain may also be displayed on the user interface 500B. All these recommendations may also be presented using various charts and/or figures in different colors. Animations may also be implemented to show potential gain or loss or any other determined results.

Further, under the recommendation text field 512, there are three options that the user may choose. Each of the options may be a button that the user can press. For example, as illustrated in FIG. 5B, the first button is “Let's reach more people” button. If the user decides to reach more people than his/her current reach, the user may press the “Let's reach more people” button. After the user presses the “Let's reach more people” button, the management module may take the user to a next user interface to show the available exhibit spaces that is 15×25 size. The user may then select a specific location of the exhibit space.

Thereafter, the user may be taken to a next visualization to show the pricing information for renting the recommended space which may include the specific rates and terms. The visualization may allow the user to print out a copy of the recommendation, receive a soft copy of the recommendation via email, save the recommendation as a soft copy (e.g., a pdf file), allow the user to send the recommendation to another person, etc.

The second button is “Out of my budget” button. If the user likes the idea of reaching more people, but the recommended booth is out of the user's budget, the user may press the “Out of my budget” button. After a user presses the “Out of my budget” button, the management system may generate an updated recommendation that recommends the user to rent a smaller booth, e.g., a 10×20 booth. Alternatively, or in addition, the management system may also prompt the user to enter his/her budget, and based on the user entered budget to generate an updated recommendation. Alternatively, the management system may recommend the user to keep his/her current size.

The third button is “keep my current size” button. If the user would like to keep his/her current size of the exhibit space, he/she may select the “keep current size” button. If the user has already paid for his exhibit space, after the user selects the “keep current size” button, the management system may generate a thank you screen or an exit screen. If the user has not paid or finalized his planned exhibit space, the management system may continue to prompt the user to finish signing the contract and pay for the current exhibit space.

FIGS. 5A and 5B merely illustrate some example user interfaces that may be presented to a user. Many different lay out and visualizations may be displayed to users. For example, all the information and fields shown on user interfaces 500A and 500B may be displayed on a single visualization or a same page of a webpage. Clicking the “recommendations” button may not be necessary. For example, after the user finishes inputting his/her information, the user interface may display the analysis results and recommendations all together or on the same screen of the user interface. The event organizer may be allowed to customize the lay out and color scheme of the user interface and to decide what types of visualizations, analysis results, and/or recommendations will be presented to its users.

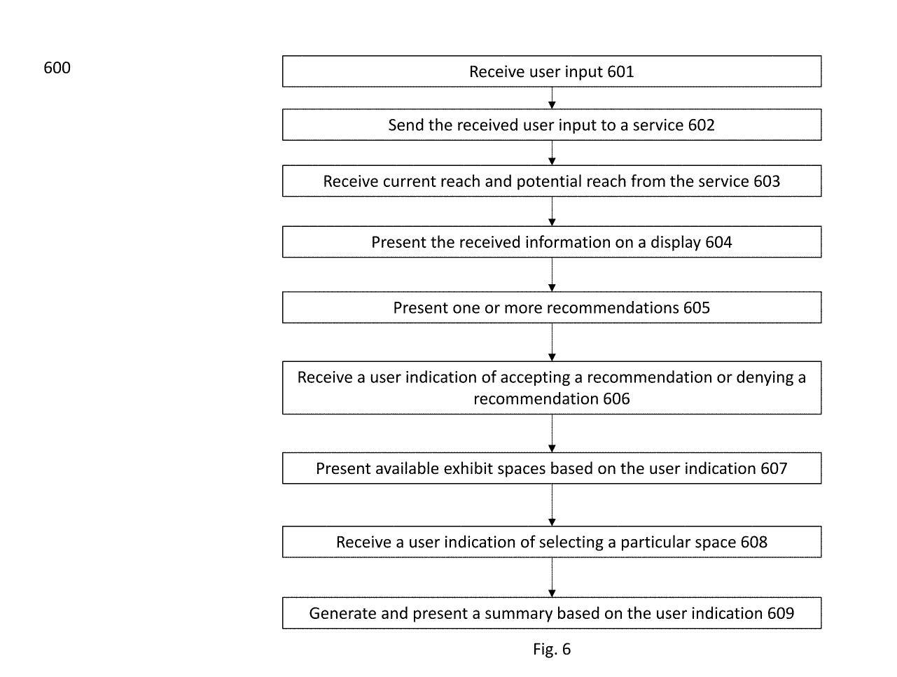

FIG. 6 illustrates a flow chart of an example method 600 that may be implemented as an application at a terminal device that is configured to interface with a user and display recommendations based on the user inputs. For example, method 600 may be implemented as an application installed on a computer terminal placed at the tradeshow event for users to book exhibit spaces. The method 600 may also be implemented as an application installed on a user's personal PC or mobile device to allow the user to plan ahead or book an exhibit space remotely. The method 600 may also be implemented as a web application accessible via a web browser.

As illustrated in FIG. 6, the method 600 includes receiving a user input 601. The user input may include the user's goals 311, the user's organization information 312, the user's existing space utilization 313, etc. After receiving the user input 601, the user input may then be sent to a service system that implements the management module 230 and/or 330 (602). If the terminal device is local to or is part of the service system, the step of sending may be a local process performed on the terminal device. If the terminal device is connected to the service system via LAN, wireless LAN, or internet network, the step of sending may be performed via the computer network that is connected to the service system.

The management module receives the user input from the terminal device and determines the current target reach and potential target reach based on the information that the user inputs, and sends the determined current target reach and potential target reach to the terminal device. The terminal device then receives the determined current reach and potential reach information from the service system (603). Based on the received information, the terminal device then presents the received information on a display (604). Different embodiments may be implemented for the terminal device to present the received information. For example, in some embodiments, service system may generate the visualization and send the generated visualization to the terminal device. In such a case, the terminal device merely renders the multi-media data received from the service system. In some embodiments, the terminal device may only receive raw data (e.g., numeral or text data) from the service system. The terminal device may include one or more chart generation modules that is configured to generate various charts based on the numeral data received from the service system.

Similarly, the terminal device may also receive one or more recommendations from the service and presents the one or more recommendations on the user interface (605). In some embodiments, the terminal device may present the determined current reach, potential reach and the one or more recommendations on the same visualization of the user interface. In some embodiments, the terminal device may wait for a user indication (e.g., press a “recommendation” button in FIG. 5A) to present the one or more recommendations on the user interface.

After the user sees the one or more recommendations, the user may further input information to indicate whether he/she wants to accept or deny at least one of the recommendations. The terminal device then receives the user indication of accepting or denying at least one of the recommendations (606). Based on the received user indication, the terminal device may then present a visualization to show one or more available exhibit space(s) (607). For example, if the user accepts the recommended larger space, the visualization may display a map showing the available exhibit spaces that are in the recommended size. Alternatively, or in addition, the visualization may also display the price of each available exhibit spaces that are in the recommended size. The visualization may also display the price of each available exhibit spaces that larger and/or smaller than the recommended size. Alternatively, or in addition, the visualization may also display the estimated target reach for each or at least some of the available exhibit spaces. The price and/or the estimated target reach may be displayed on the map next to each corresponding exhibit space. Different colors may be used to represent different types of exhibit spaces. For example, available exhibit spaces may be in one color, the not available exhibit spaces may be in a different color, recommended exhibit spaces may be in another different color, not recommended exhibit spaces may be in another different color, a smaller than recommended exhibit space may be in another different color, and/or a larger than recommended exhibit space may be in another different color, etc.

After receiving the display of the recommended spaces, the user may then enter an input to indicate which exhibit space the user wants to select. The terminal device will then receive the user indication of selecting a particular space (608). For example, if a map of available exhibit spaces is displayed on the user interface, the user may select a particular exhibit space on the map. If a list of different size of exhibit spaces is displayed on the user interface, the user may simply select a size on the list. After receiving the user indication of selecting one or one type of exhibit space, the terminal device may then generate and present the user a summary including the rates and terms of the selected space (608). Many different ways of storing, receiving, and/or displaying the summary may be presented to the user (609). For example, the user may be able to save the summary as a soft copy (e.g., a pdf file), the user may be able to email the summary to himself or his partners, the user may be able to print the summary out, etc.

Some of the information displayed on the user interface of the terminal device may be generated by the service system remotely. Some of the information displayed on the user interface of the terminal device may be generated by the terminal device. Different embodiments may be implemented to cause the service system and/or the terminal device to make certain determinations and/or to generate certain portion(s) of the visualizations displayed on the terminal device.

For the processes and methods disclosed herein, the operations performed in the processes and methods may be implemented in differing order. Furthermore, the outlined operations are only provided as examples, an some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicate by the appended claims rather than by the foregoing description. All changes which come within the meaning and range of equivalency of the claims are to be embraced within their scope.

What is claimed is:

1. A computing system comprising:
one or more processors; and
one or more computer-readable media having thereon computer-executable instructions that are structured such that, when executed by the one or more processors, cause the computing system to:
receive a user input;
based on the user input, determine a target audience profile;
access a database that includes information about a set of members of an audience attending an event, the information including one or more attributes of each of the set of members;
based on the determined target audience profile and the information about the set of members of the audience attending the event, identify a subset of members whose attributes substantially match the target audience profile; and
based on the identified subset of members, determine a target audience reach.

2. The computing system of claim 1, wherein the information includes attribute information related to a past event; and
wherein identifying the subset of members includes identifying a subset of members that attended the past event.

3. The computing system of claim 1, wherein the information includes attribute information related to a current event; and
wherein identifying the subset of members includes identifying a subset of members that are attending the current event.

4. The computing system of claim 1, wherein the user input includes information related to a historical audience reach.

5. The computing system of claim 1, further configured to generate a visualization to display a current audience reach and the target audience reach.

6. The computing system of claim 1, further comprised to:
based on the determined target audience reach, generate a recommendation of one or more space sizes or space locations related to the event.

7. The computing system of claim 6, further configured to generate a visualization to display the recommended one or more space sizes or space locations related to the event.

8. The computing system of claim 1, wherein the user input includes one or more of the followings: user organization information and audience reach goals.

9. The computing system of claim 1, further comprising:
determining a current audience reach for a particular space size or space location related to the event based on the user input;
comparing the current audience reach to the target audience reach; and
based on the comparison, generating one or more of updated space recommendations or space utilization plan.

10. The computing system of claim 1, wherein the attribute information comprises one or more of the followings: demographics information and organization information of the set of members.

11. A method for managing tradeshow vendors using a computing system, comprising:
receiving a user input;
based on the user input, determining a target audience profile;
accessing a database that includes information about a set of members of an audience attending an event, the information including one or more attributes of each of the set of members;
based on the determined target audience profile and the information about the set of members of the audience attending the event, identifying a subset of members whose attributes substantially match the target audience profile; and
based on the identified subset of members, determining a target audience reach.

12. The method of claim 11, wherein the information includes attribute information related to a past event; and
wherein identifying the subset of members includes identifying a subset of members that attended the past event.

13. The method of claim 11, wherein the information includes attribute information related to a current event; and
wherein identifying the subset of members includes identifying a subset of members that are attending the current event.

14. The method of claim 11, wherein the user input includes information related to a historical audience reach.

15. The method of claim 11, the method further comprising:
generating a visualization to display a current audience reach and the target audience reach.

16. The method of claim 15, the method further comprising:
based on the determined target audience reach, generating a recommendation of one or more space sizes or space locations related to the event.

17. One or more hardware storage devices having stored thereon computer executable instructions, the computer-executable instructions being executable by a computer system that causes the computer system to:
receive a user input;
based on the user input, determine a target audience profile;
access a database that includes information about a set of members of an audience attending an event, the information including one or more attributes of each of the set of members;
based on the determined target audience profile and the information about the set of members of the audience attending the event, identify a subset of members whose attributes substantially match the target audience profile; and
based on the identified subset of members, determine a target audience reach.

18. The one or more hardware storage devices claim 17, wherein the information includes attribute information related to a past event; and
wherein identifying the subset of members includes identifying a subset of members that attended the past event.

19. The one or more hardware storage devices claim 17, wherein the information includes attribute information related to a current event; and
wherein identifying the subset of members includes identifying a subset of members that are attending the current event.

20. The one or more hardware storage devices claim 17, wherein the user input includes information related to a historical audience reach.
